(19) United States
(12) Patent Application Publication
(10) Pub. No.: US 2003/0105827 A1
(43) Pub. Date: Jun. 5, 2003

(54) Method and system for contextual prioritization of unified messages

(76) Inventors: Eng Siong Tan, Jalan Bukit Ho Swee (SG); Choong Y. Chew, Redwood City, CA (US); Chee Meng Low, Singapore (SG); Cy Boon Teoh, Singapore (SG); Boon Siong Wong, Masai (MY)

Correspondence Address: Mark J. Spolyar, Law Office of Mark J. Spolyar, 175 Peralta Ave., San Francisco, CA, 94110, US

(21) Appl. No.: 10/304,541

(22) Filed: Nov. 26, 2002

Related U.S. Application Data
(60) Provisional application No. 60/334,388, filed on Nov. 30, 2001.

(51) Int. Cl. G06F 15/16

(52) U.S. Cl. 709/206

(57) ABSTRACT

Methods, apparatuses and systems allowing for the contextual prioritization of messages and, in one embodiment, unified messages. Embodiments of the present invention are operative to associate a relevance measure to unified messages by computing the context of the message in relation to both the message recipient and the message initiator. Relevance measures, in one embodiment, allow for a contextual prioritization of unified messages into a plurality of context-based categories.

### RELATED APPLICATION

The present application claims priority from provisional application serial No. 60/334,388 filed Nov. 30, 2001 and entitled “Method and System for Contextual Prioritization of Unified Messages.”

### FIELD OF THE INVENTION

The present invention relates to messaging systems and, more particularly, to unified messaging systems providing relevance indicators corresponding to received messages.

### BACKGROUND OF THE INVENTION

In today's information age, there are a variety of communication methods commonly used by businesses and individuals, including voice, fax, email, instant messaging, etc. As the number of communication methods increase, so does the number of messages business professionals and other individuals must manage and be responsive to every day.

Unified messaging facilitates management of all such messages by providing a single point of access to different message types, such as voice, fax, and email, from a variety of communications devices, such as a wireless telephone, personal computer or Web browser through the Internet. In the user's email inbox, a unique icon identifies each message type. Users can also access and manage messages through a telephone interface. Using a telephone interface, a user can dial into his unified messaging system from any telephone to listen and respond to almost any message type waiting in an inbox. For example, the user can listen to their email messages using text-to-speech technology and respond to that email message with a voice message. The user can listen to the header of a fax message, forward that message to someone else, or even send it to the closest fax machine. In addition, a graphical user interface allows users to log in to a unified messaging system and access their messages with a desktop or laptop computer.

The increasing adoption of unified messaging indicates a growing trend toward the convergence of disparate message types on one device. For example, Handspring®, Inc. and Palm®, Inc. have announced their intention to add call capabilities to their respective lines of Personal Digital Assistants (PDAs). Research In Motion, Inc. intends to add voice calling capabilities to its Blackberry® wireless email devices. Nokia's Communicator® combines PDA functionality with wireless phone technology. Japan's NTT DoCoMo I-Mode hand-phones provide both email and voice-calling capabilities. This trend will only exacerbate the information and attention overload problem caused by the variety of messages accessible on a single device. Already, the overload of unwanted emails alone has received much attention giving rise to the creation of sophisticated spam filters and equally sophisticated methods of evading them. Likewise, the increasing frequency of mobile phone interruptions has lead to development of phone jamming products. Current screening technologies, however, pose certain problems for unified messages. For example, such screening technologies are not adapted to unified messages as they operate only on a single message type. Moreover, such screening technologies are ill-suited to handle the large number of messages a user typically receives, as such filter and screening technologies operate in a binary manner accepting “good” and rejecting “bad” messages.

### SUMMARY OF THE INVENTION

The present invention provides methods, apparatuses and systems allowing for the contextual prioritization of messages and, in one embodiment, the contextual prioritization of unified messages. Embodiments of the present invention are operative to associate a relevance indicator or category to unified messages by computing the context of the message in relation to both the message recipient and the message initiator. Relevance measures, in one embodiment, allow for a contextual prioritization of unified messages into a plurality of context-based categories.

The present invention has application to any unified message type, including voice-based messages, such as telephone calls and voice-mail messages, and multimedia electronic messages, such as electronic mail (email), short message service (SMS), instant messaging, faxes, and the like.

### DESCRIPTION OF THE DRAWINGS

The present invention is described with reference to the following figures:

FIG. 1 is a functional block diagram providing an overview of a system according to a preferred embodiment of the present invention.

FIG. 2 is a functional block diagram setting forth the functionality and process flows associated with computing a message recipient's context relative to an incoming message, according to a preferred embodiment of the present invention.

FIG. 3 is a process flowchart describing a method for computing a message recipient's interest level in an incoming message, according to a preferred embodiment of the present invention.

FIG. 4 is a process flowchart describing a method for inferring a message initiator's context based on the initiator's profiled identity and profiled content, according to a preferred embodiment of the present invention.

FIG. 5 is a flowchart diagram of a preferred method for computing the relevance of a unified message, according to the present invention.

FIG. 6 is a flowchart of a preferred method for computing the relevance of a telephone message, according to an embodiment of the present invention.

FIG. 7 is a flowchart diagram setting forth a method for computing the relevance of an electronic mail message, according to a preferred embodiment of the present invention.

### DESCRIPTION OF PREFERRED EMBODIMENT(S)

1. Exemplary Operating Environment

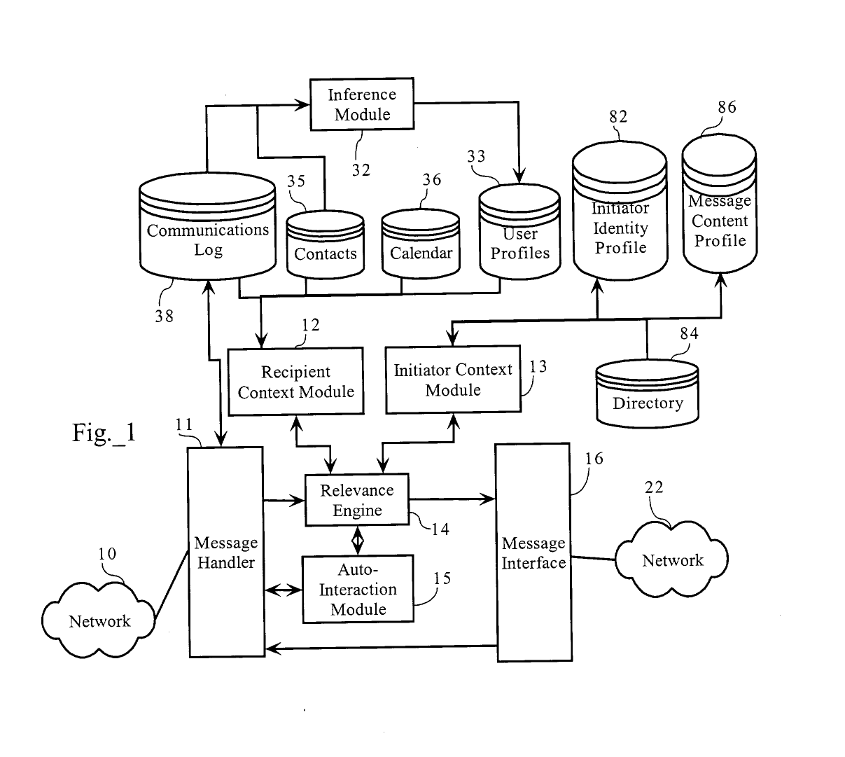

FIG. 1 illustrates a communications network environment in which embodiments of the present invention may operate. In reference to FIG. 1, the system, according to one embodiment of the invention, comprises message handler 11, recipient context module 12, initiator context module 13, relevance engine 14, auto-interaction module 15, and message interface 16. Message handler 11 is operative to interface with a communications network 10 for receiving and sending unified messages on behalf of a user. Recipient context module 12 is operative to compute a recipient's context in relation to a received message. Initiator context module 13 is operative to compute the message initiator's context in relation to a received message. Relevance engine 14 is operative to compute the relevance of a received message based on the recipient's and, optionally, the initiator's respective contexts. Auto-interaction module 15 facilitates relevance computations by auto-interacting with a message initiator on the recipient's behalf. Auto-interaction module 15 is also operative to provide notices or other information to message initiators. Message interface 16 provides an interface to users facilitating access to message sending and retrieval functionality. Message interface 16, in one embodiment is operative to process the prioritized messages into appropriate inbox folders based on relevance measures computed by relevance engine 14 and allows access to messages for perusal by the recipient. Message interface 16, in one embodiment, is also operative to display or otherwise present prioritized messages in a folder-based inbox interface, and further allows recipient users to reply to received messages or to send new messages.

The present invention can be applied to any unified message type, which includes any combination of voice-based messages including but not restricted to telephone calls and voice-mail messages, as well as any multimedia electronic messages, including but not restricted to electronic mail (email), short message service (SMS), instant messaging and faxes. In addition, a unified message may be initiated by a human, a software application or a machine.

2. Computing a Recipient's Context Relative to an Incoming Message

For a given unified message from a message initiator, recipient context module 12 computes the Recipient's context to identify a contact relation between the Recipient and the Initiator, and, in one embodiment, potentially a level of interest the recipient may have in the message. In one embodiment, recipient context module 12 categorizes the recipient's context with respect to a received message into one of a plurality of contact relation types relative to the initiator of the message.

2.a. Generating Initiator/Recipient User Profiles

Computing the Recipient's context, in one embodiment, involves a background pre-processing step of generating and maintaining user profiles by making inferences based on the user's past communications behavior as recorded by communications log 38. Communications log 38 can acquire data from a variety of sources, such as the logs maintained by the user's telecommunications provider that provide per-call information such as the numbers of calls sent or received, telephone numbers dialed, time and duration of calls made, etc. Other possible sources include email logs or archives that contain per-email information such as sender or recipient addresses, copied addresses, date and time, subject, and message body. Such log information is already being used by the users themselves or by trusted communications services providers, for services such email archiving, email filtering or call billing. In one embodiment, an SMTP server associated with a user is operative to transmit data allowing for logging of the user's emails for purposes of populating communications log 38. In one embodiment of the invention, this information is accessed by interfacing the recipient context module 12 to the communications service provider's message handler 11 so all communications going through message handler 11 are logged automatically. In addition, another possible data source is contacts database 35 (see FIG. 1) containing the user's address book and other contacts information, such as names, addresses, telephone numbers, email addresses, etc.

In one embodiment, inference module 32 analyzes and makes inferences from the data stored in communications log 38 and contact database 35 to segregate the user's contacts into a pre-defined set of contact relation types. An illustrative set of contact relation types associated with a user profile is as follows:

Contacts that are Related to the user;

Contacts that are Trusted to the user;

Contacts that are Familiar to the user;

Contacts that are Known to the user; and

Contacts that are Unknown to the user.

Inference module 32, in one embodiment, applies inference rules to data associated with a user in communications log 38 and/or contact database 35 to generate, and later update, contact relation types associated with the user. An exemplary set of inference rules based on contact identity, communication pattern and frequency of communication events in communications log 38 and/or contact database 35, is as follows:

Inference of a Known contact:

The user has sent a unified message to the contact at least once.

Inference of a Familiar contact:

There are at least 2 sent-and-reply message pairs between the user and the contact.

Inference of a Trusted contact:

A contact who is Familiar to user; AND

The number of messages exchanged between the user and the contact within the last 3 months exceeds 20.

Inference of a Related contact:

A contact who is Trusted to the user AND

Matches at least one of the following “affinity” tests:

The contact has the same email domain, not including domains belonging to Internet email service providers

Has the same residential OR business number

Otherwise, the contact is an Unknown contact.

Inference module 32, in one embodiment, performs this background profiling step for each user on a periodic basis to populate and later update user profile database 33 to contain the user-contact pairs and profiles of the user-contact pairs encountered by the system. In one embodiment, the system of the present invention includes user-access functionalities facilitating access to user profile database 33, such that users can peruse the profile database directly as well as override existing system-defined profiles and contact relation types, or create entirely new ones.

2.b. Computing Recipient's Context

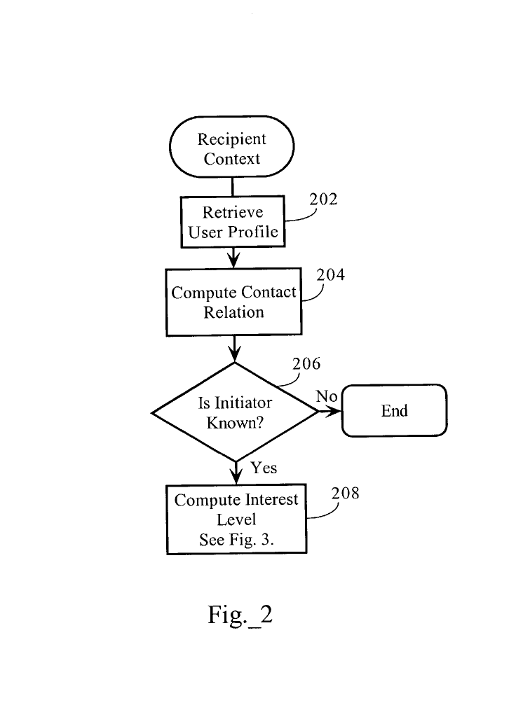

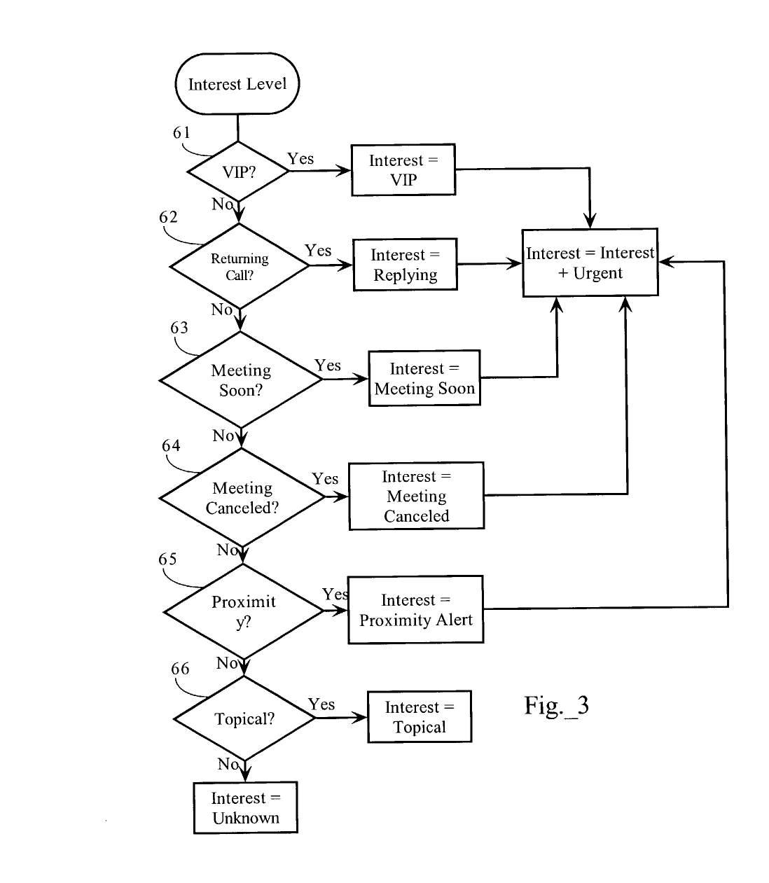

FIGS. 2 and 3 are functional block diagrams illustrating a process flow associated with computing a recipient user's context relative to a received message. As the following provides recipient context module 12 draws information from user profile database 33, communications log 38, contact database 35, and calendar database 36 to compute a recipient's context and infer a recipient's interest level in a received message based on a set of heuristic rules. The operation of computing a recipient's context relative to a message begins with a retrieval of a contact relation associated with the recipient user from user profile database 33 (FIG. 2, step 202). The retrieved contact relation, together with the message, is passed to recipient context module 12 for heuristic processing of the recipient's contact relation type with respect to the initiator (step 204) (see above) and, if the initiator is known to the recipient (step 206), an overall Interest level associated with the message (step 208), based on accessible information about the user's context, such as calendar information 36, contact database 35, location and interests.

FIG. 3 illustrates an exemplary set of heuristic rules that can be applied to determine a recipient's interest level in a received message:

The “VIP” Heuristic (61): This rule checks the priority of the initiator to determine if the message should be marked as “urgent”. For example, messages whose recipient-initiator contact relations types are Related or Trusted can be deemed urgent. As another example, initiators appearing in the recipient's contacts database 35 and whose relationship or title indicates the initiator is the recipient's superior, can be deemed urgent. In one embodiment, parameters associated with the VIP heuristic are configurable by the user. For example, the user may configure a list of VIPs.

The “Returning a Call” Heuristic (62): Recipient context module 12 scans the communications log 38 to detect if the recipient has unsuccessfully attempted to contact the initiator in the recent past. In one embodiment, the heuristic rule requires a threshold number of unsuccessful attempts within a predetermined period. This will be reflected in the communications log as a multiplicity of unanswered telephone calls and/or emails from the recipient to this contact. When such an event is detected, the message is marked as “Replying” and will be treated by relevance engine 14 as “urgent” regardless of past communication patterns.

The “Meeting Soon” Heuristic (63): This rule checks the recipient's calendar as maintained by calendar database 36 to see if the initiator is a participant in a soon-to-occur event on the recipient's schedule. Recipient context module 12 associates such messages with a “meeting soon” tag. Such messages are further marked with an urgent or moderately urgent message tag. A further variation is to vary the degree of urgency based on additional factors, for example, the sooner the scheduled event to the time of the call, the higher the level of urgency assigned to it by the recipient context module 12.

The “Meeting Canceled” Heuristic rule (64): This rule applies the “Meeting Soon” rule, and for the case of electronic data messages, further processes the message content for keywords such as “sorry”, “cancel”, “postpone”. Such messages are further marked with an urgent or moderately urgent message tag. A further variation is the vary the degree of urgency based on additional factors, for example, the sooner the scheduled event to the time of the call, the greater the urgency the message is accorded.

The “Proximity” Heuristic (65): This rule checks if the message initiator is designated as Trustworthy (either through direct user input, or based on system computed contact relation types of Related or Trusted) and whether the message contains any location-based information. The recipient's location-context is checked to see if she is “close by”. If so, the message is marked “Proximity Alert” and its urgency level increased. This rule is particularly apt for mobile-commerce class of messages from recipient's selected list of businesses.

The “Topical Interest” (66): This rule checks the message contents for indications that the recipient is interested in this topic. An illustrative examples include use of selected keywords configured by the user to match a category of interest (“sports”, “footballs”, “baseball” to match sports-related messages). Another illustrative example is the monitoring of mail logs to identify messages related to a project, for example by tracking discussion threads (emails whose SUBJECT has “RE:” followed by the same topic), scanning for the frequently-occurring distinguishing keywords in the message body (e.g., project name or client name), plus the occurrence of the usual members in the FROM, TO, CC, or BCC list. Such messages are marked “Topical.”.

The “Meta-Message” Heuristic: This rule checks for a special class of messages that are distinguished from other messages in two ways, namely, the message is from a controlled class of initiators (such as the communications service provider or from specially registered applications), and the message's content is intended not for perusal by the recipient himself, but rather is intended to influence the recipient's interest levels in other messages. Illustrative examples include a meta message from the mobile phone operator indicating the recipient has moved into a new cell location code, and updating a location state with the new current location code. This can then be used to trigger the “Proximity” heuristic.

A further variation of the above system is the addition of an automatic monitor of the recipient's context, such as location, to determine if changes in the recipient's context warrant a re-computing of the relevance of prioritized messages. In one embodiment, a user's location can be determined in relation to the current wireless cell phone area in which the user's wireless device is located.

3. Computing an Initiator's Context Relative to an Incoming Message

For a given unified message from an initiator, initiator context module 13 determines the initiator's context by computing the initiator's identity profile, and a content profile for the message.

3.a. Initiator Identity Profile

An aspect of computing an initiator's context includes a processing step in which the identity profile of the initiator is computed to determine the level of interest a recipient may have for a particular initiator, even if the initiator is unknown to the recipient. This process accesses previously computed initiator identity profiles in database 82, recipient user profiles from user profile database 33, and/or a phone directory 84 that permits reverse directory lookups.

3.a.1. Affinity Relations

As an aspect of computing the initiator's identity profile, initiator context module 13 checks for affinity relations in the initiator's and recipient's communications patterns that can suggest that a recipient would be interested in communicating with the initiator even if there are no prior communications between them. As an illustrative example, initiator identity profiles can be computed from the following rules based on affinity relations:

“Friend of a Friend” Affinity rule: This rule accesses the user profile database 33 to check if the initiator and the recipient share any Related, Trusted or Familiar contacts, indicating whether the initiator and recipient “travel in the same circles.” In one embodiment, this can be accomplished by matching the entire contact list associated with the user profile for the recipient against the same for the initiator. The number of common contacts, as well as the contact relation types associated therewith, are used in computations of an affinity level. As an illustrative example, a recipient and an initiator are considered “Friend of a Friend” if any one of the following is true:

a. there is at least 1 Related contact in common;

b. there are at least 2 Trusted contacts in common;

c. there are at least 5 Familiar contacts in common; and

d. there are at least 10 common contacts of any contact relation type.

“Common Background with Recipient” Affinity rule: This rule analyzes the various specific identities of both the initiator and recipient for common background. As illustrative examples, phone numbers can be searched against phone directory 84, using reverse directory lookup methods, to reveal if the phone number is from a company, a residential address or an unlisted number. The recipient and the initiator are related by “Common Background” if any of these are true:

a. Both phone numbers are business numbers and are from the same company;

b. Both phone numbers are residential numbers and are from the same residential address; or

c. Both email addresses share the same internet domain, unless the domain is associated with an email or internet service provider.

“Common background with Recipient's contacts” Affinity rule: This rule applies the criterion set forth in the above “Common Background” rule to infer an affinity relation from contact relations, if any, between the initiator and any of the recipient's Related, Trusted or Familiar contacts.

3.a.2. Bona Fide Initiator Identification

A second aspect of initiator identity profiling is to check if the initiator is associated with a bogus identity or bona-fide identity (e.g., phone number, email address, etc.). An initiator identity can be a phone number, an email address or any other suitable identification. This check is especially important for the unified message type of emails. Since the bulk of email messages are not authenticated, forgery of the “From” address is a particularly common practice among email spammers. An illustrative example of computing the bona-fide relation is as follows:

Bona-Fide Identity rule: This rule accesses the user profile database 33 to retrieve all contacts associated with the initiator. If the initiator has at least 3 Trusted contacts or 10 Familiar contacts, the initiator is marked as Bona-Fide. The actual thresholds used can be varied and fine-tuned. One variation is to permit user programmable thresholds. Another is to adapt the thresholds based on actual system performance.

3.a.3. Identity Profile Database

A third aspect of the identity profiling is the maintenance of a database that logs all previously computed identity profiles. This provides a system memory for remembering initiators, and reduced redundant processes associated with computing initiator identity profiles. Hence this database is designed for efficient access. Likewise every new initiator identity profile computed is also logged into the database 82.

3.b. Message Content Profile

In one embodiment, initiator context module 13 computes a content profile for the message to determine the likelihood that the message is a bulk message or SPAM sent by an initiator, alien not only to this recipient but also to almost all of its recipients. This process also accesses message content database 86 storing previously computed message content profiles.

An illustrative example of processing message content profiles generally comprises the following steps:

Compute a message signature: A representation of the message is computed that is more suitable for processing in subsequent steps. As an illustrative example, a telephone call can be processed through an automatic speech-to-text recognition processor (such as is available from companies such as Nuance, SpeechWorks, etc.) to obtain the electronic digital version of the message. The electronic digital versions of the message are then stored in a form for efficient processing. As an illustrative example, an email can be stored as a word-frequency vector (a string of words together with their frequency counts in the message), a representation commonly used in information retrieval applications.

Normalize the message signature. This processing further abstracts the message signature to capture the essential parts of the message and ignore the minor variations of the same message. An illustrative example is the removal of commonly-occurring words (known as stop words in information retrieval applications). Another illustrative example is the removal of all number sequences in the message. Another illustrative example is to store only representations of selective fields in structured messages, such as ignoring the FROM, TO, SUBJECT, and DATE fields and representing only the message BODY. Another illustrative example is to identify and extract contact identities (phone numbers or email addresses) contained in the message.

Compute a unique identification for the message signature. This processing step computes a highly likely unique identification for a given normalized message signature. An illustrative example is the application of the widely used message digest algorithm used in digital signature applications. MD5 processing that takes a string and returns a 128-bit fingerprint or message digest of the string that can serve as the message's unique identification.

The content profile of a message, in one embodiment, comprises a unique message identification, a normalized message signature, and a message count), where the message count keeps track of the number of minor variations of the same message encountered by the system, as represented by the normalized message signature.

A message content profile database 86 allows for tracking the number of similar messages encountered by a system of the present invention. The unique message identification is used to index the message content profiles, and can be used as a primary key into a database storage, or as a key to a hash table.

In one embodiment, if the message of an unknown initiator has a normalized email signature that has a high count, the message is deemed to match a spam content profile.

3.c. Overall Process Flow for Computing Initiator Context

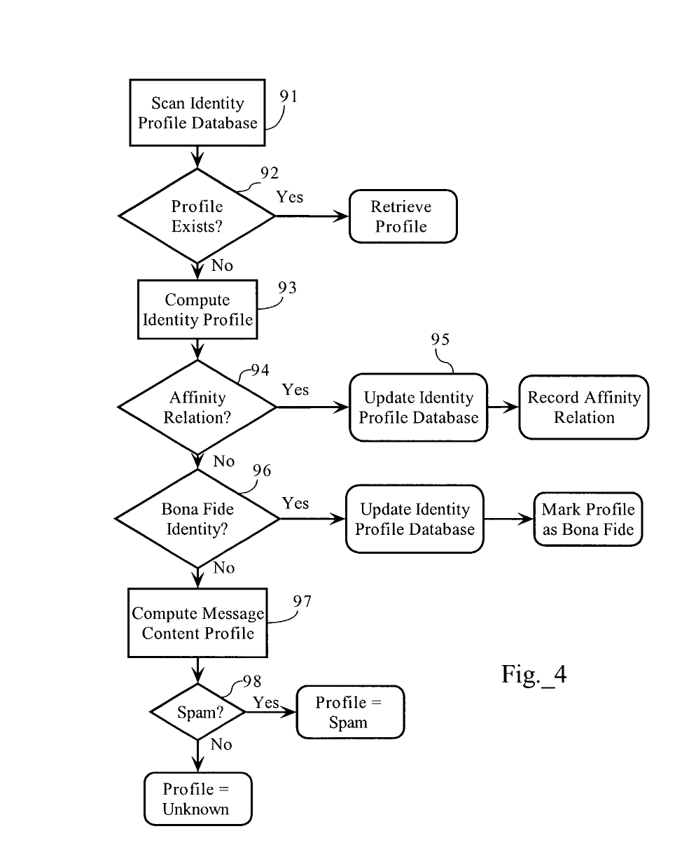

In reference to FIG. 4, the process flow of computing an initiator's context begins with accessing initiator identity profile database 82 to determine the contact relation type, if any, between the initiator and the recipient (step 91). If a computed contact relation type already exists for the initiator (step 92), the contact relation type is retrieved and the process exits. Otherwise, initiator context module 13 creates an initiator identity profile in initiator identity profile database 82 (step 93) and applies the checks discussed above. If the profile fits an Affinity profile (94), the corresponding entry in initiator identity profile database 82 is updated to reflect this new initiator-affinity pair (95), the profile is marked “Affinity” and the process exits. If the profile fits a Bona-Fide profile (96), the identity profile database is updated to reflect this new initiator-profile pair, the profile is marked “Bona-Fide” and the process exits. If the profile is neither an Affinity nor a Bona-Fide, the content profile of the message is computed and the count of the matching content profile is incremented (97), and the results checked. If the profile fits a Spam content profile (98), the profile is marked “Spammer” and the process exits. Any messages left are marked with the profile “Unknown” and the process exits.

4. Auto-Interaction Module

In reference to FIG. 1, auto-interaction module (15) provides a means for the system of the present invention to autonomously interact with an initiator, using the same message type used by the initiator, to send, receive and process information. Information gathered by auto-interaction module 15, by interacting directly with the initiator, provides further criterion for establishing the relevance of a given message.

As an illustrative example, auto-interaction module 15 allows a system of the present invention to interact directly with message initiators over a wired or wireless telephone. In a preferred embodiment, this can include VXML-based speech interface technologies that allows queries from the system to be transformed into appropriate speech for voice-based communication to the caller using text-to-speech conversion. Likewise automated speech-to-text recognition software can be employed to capture inputs relayed by the caller to the system for processing. A further variation is the additional use of DTMF processing to allow user input through keying of characters rather than speaking.

Such a system can be employed for numerous applications within the system of the present invention. In one preferred embodiment related to a known caller, auto-interaction module 15 can interact with calendar database 34 to inform the initiating caller about the recipient's current context (e.g., he is in a meeting until 4 pm). In another embodiment, auto-interaction module 15 can help initiating callers schedule a time for callback, by presenting the recipient's open time slots and offering the caller to select a slot. In yet another embodiment, auto-interaction module 15 can select from a user-definable library of voice templates for use in text-to-speech interface, to allow for the recipient to personalize the interactions with different initiators.

As another illustrative example, auto-interaction module 15 can also allow a system of the present invention to interact directly with initiators of email. Auto interaction module 15 can automatically process an email to reply to the initiator with an appropriately worded message. Such a system can be employed for numerous applications. In one preferred embodiment related to a known initiator, auto-interaction module 15 can include information providing the recipient's contextual information (e.g., he is out of town and won't check email until next Monday). In another embodiment related to an unknown initiator, auto-interaction module 15 can request further actions from the initiator to verify an affinity relationship to the recipient or to determine whether the initiator's identity is bona fide. For example, typical email spamming applications do not respond to email messages. In one embodiment, if auto-interaction module 15 does not receive a responsive email within a threshold period of time, the initiator identification is assumed to be bogus.

5. Computing Relevance of Incoming Unified Messages

For a given unified message from an Initiator, relevance engine 14, in one embodiment, computes the relevance measure of the message based on the Recipient's and Initiator's contexts provided above.

In one embodiment, relevance engine 14 receives a message and sends it to recipient context module 12 to compute the recipient's context comprising at least the contact relation type between initiator and the recipient and, potentially, an interest level. An optional further processing step involves sending the message to initiator context module 13 to compute the Initiator's context. Another optional further processing step involves accessing the auto-interaction module 15 for the system to autonomously interact with the initiator directly on the recipient's behalf to establish relevance of the message. Upon processing these inputs, relevance engine 14 prioritizes the message into a number of contextually prioritized folders.

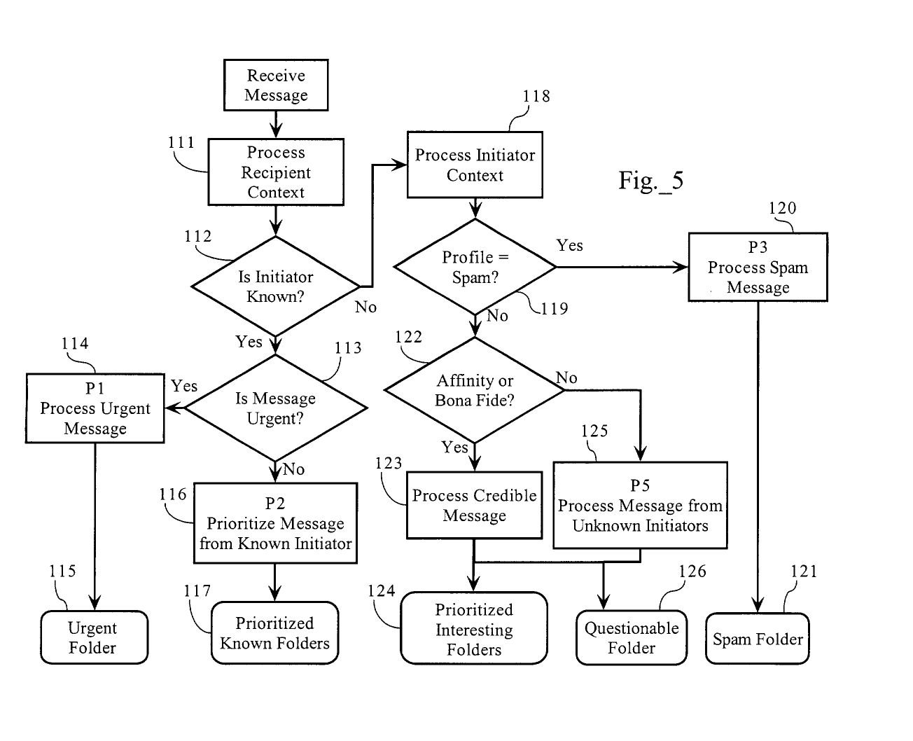

FIG. 5 is a process flow diagram illustrating the computation of a relevance measure. As FIG. 5 shows, recipient context module 12 computes the recipient's context relative to a received message (step 111). The computed recipient-initiator profile is tested (step 112). If the initiator is known to the recipient, the interest level is checked to see if the message is urgent (step 113). Urgent messages are processed in P1 (step 114) and prioritized into the “Urgent” folder (115). Non-urgent messages are processed in P2 (step 116) and prioritized into one of possibly many folders for known initiators (117).

If the recipient-initiator contact relation type is Unknown and hence the recipient does not know the initiator (step 112), the Initiator's context is computed (step 118). The computed identity profile is tested (step 119). If the profile fits that of a spammer, the spamming message is processed in P3 (step 120) and prioritized into a “Spam” folder (121). Otherwise, if the initiator identity profile is bona fide or is associated with an affinity relation (step 122), then the message is processed as a credible message (step 123) and the message is prioritized into one of possibly many folders for unknown but probably interesting folders (124), or possibly into a “Questionable” folder (126). The remaining messages from truly unknown initiator are processed in P5 (step 125) and the results prioritized into a “Questionable” folder (126), or possibly one of the unknown but interesting folders (124).

6. Exemplary Process Flow for Telephone Call

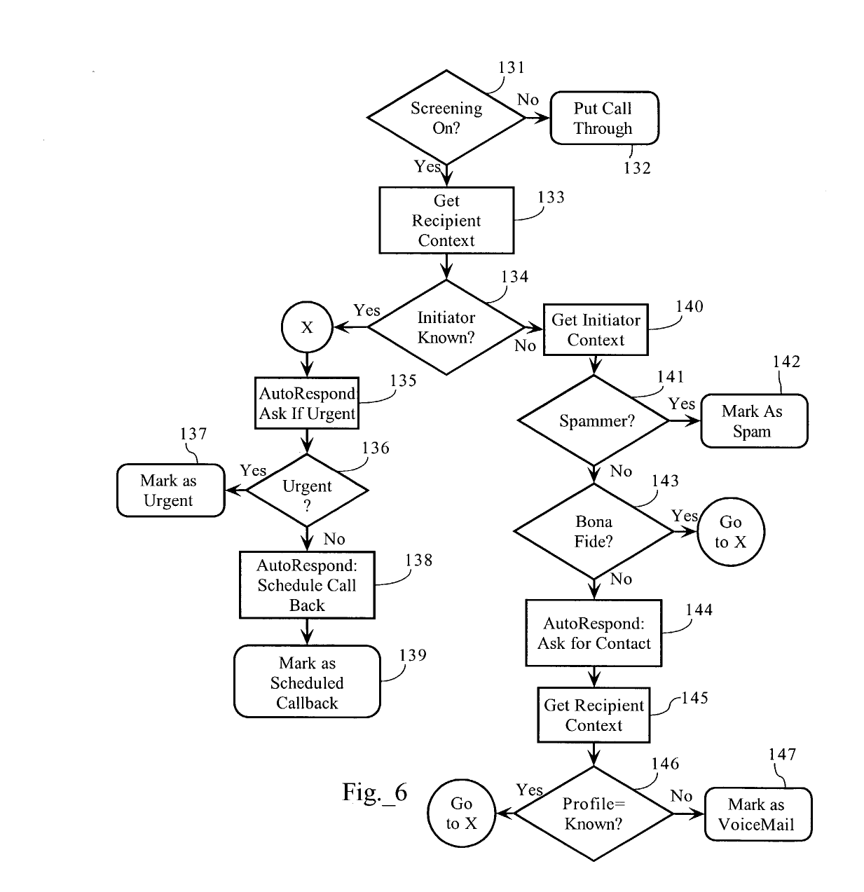

FIG. 6 shows an illustrative example of a process flow for handling a unified message of the type telephone call by a system configured according to an embodiment of the present invention. For this embodiment, it is assumed that the communication logs 38 and the daily schedule or calendar 36 of the subscribers to the service are available. It is further assumed that the telecommunications service provider has necessary provisioning systems in place to detect if a recipient is a subscriber to this service, and to route only calls to subscribers to the contextualized prioritization system of the present invention.

A call made by the initiator to the recipient is received by the telecommunications network 10 where information about the call, such as the caller and recipient identification number, is accessible. A further variation of the present inventive system is to perform a check here to see if the recipient has set the call-screening mode to be on or off (step 131). If call screening is off, then calls are treated as per normal (step 132) and not routed through to the present inventive system. Otherwise, the call information together with the call is then routed to message handler 11.

Processing of the call begins with passing the caller and recipient identification number (either a phone number or “unlisted” marking) to recipient context module 12 to compute the recipient's context (step 133). The resulting computed contact relation type is checked (step 134).

If the caller is known, the auto-interaction module 15 is invoked to interact on behalf of the recipient to enquire of the caller as to the urgency of the call (step 135). As an illustrative example, auto-interaction module 15 can prompt the user with the message “Hi I'm sorry John is in a meeting right now. Do you want me to interrupt him? Please say yes or no”. Using automatic speech recognition or DTMF interface, auto-interaction module 15 captures the user's input (Yes or No). A further variation of this example is to restrict this urgency checking to only those callers with higher priority levels, for example, to callers whose contact relation types are Related or Trusted, but not for callers whose contact relation types are Familiar or Known.

If the caller responds that the call is urgent (step 136), the call is put through to the recipient regardless of the screening mode. In the event the call is not connected (e.g., because the recipient did not pick up the phone), a voice message is taken and the missed call is placed into the urgent message folder (137), which is accessed by the message interface 16 to notify the recipient of the new message. Otherwise, calls from known callers but which are not sufficiently important to interrupt the recipient, are contextually prioritized. In this illustrative example, auto-interaction module 15 is invoked to contextually prioritize calls by scheduling a callback appointment with the caller, using the recipient's daily schedule as a context (step 138). An exemplary prompt by auto-interaction module 15 is “Hi, John is available today for a 15 min call at, option 1, 12:30 pm, option 2, 5 pm, or option 3, leave a message. Please select an option.” As a result, calls from known callers are now prioritized using the schedules of both the recipient and the initiator as contexts. The scheduled callbacks, together with voice messages if any, are marked by their times and placed into a prioritized missed call folder (step 139) which is accessed by message interface 16 to allow for message retrieval by the recipient.

A further variation of this example is to restrict this call scheduling prioritization to only those callers with higher priority levels, for example, to callers whose contact relation types are Related or Trusted or Familiar, but not for callers whose contact relation types are Known, who are permitted only to leave voice messages.

Another variation of step 138 is to prompt the caller for the times slots when the recipient can call back, rather than presenting the open slot options of the recipient. An exemplary prompt by auto-interaction module 15 might be “When would you like John to call you back. Please specify a time followed by am or pm.”

Another variation of step 138 is to prioritize missed calls by the initiator's profile; for example, calls from Related callers are ranked before calls from Trusted callers, which are placed before calls from Familiar callers, etc.

If, however, the caller is unknown to the recipient (step 134), the caller's identification number (either a phone number or “unlisted” marking) is passed to the initiator context module 13 to compute the initiator's context (step 140). The resulting computed initiator identify profile is checked (step 141). If the computed identity profile matches that of a Spam profile (step 141), then the call is not connected and is placed into a “Spam” folder (step 137), which is accessed by message interface 16 to notify the recipient and allow for message retrieval by the recipient.

If the computed identity profile is bona fide or is associated with an affinity relation (step 143), the caller is deemed an unknown but credible caller. The call is then treated as a call from a known caller, and, in one embodiment, re-routed to step 135. The remaining calls are deemed to be from unknown callers who do not match Spammers nor Bona-fide profiles. Such calls cannot be simply ignored, since many calls can be made by close contacts from public phones, new office locations or borrowed phones, etc. In one embodiment, processing of these calls involves the use of auto-interaction module 15 to prompt the caller to provide an equivalent identity by supplying a contact or initiator identity previously used to communicate with the recipient (step 144). An exemplary prompt by auto-interaction module 15 might be “Hi, I'm sorry I do not recognize you. To proceed, please enter a phone number or email that you have used to contact John before.” The contact provided by the user is passed to the recipient context module 12 for re-computation (step 145) and the resulting contact relation type is checked (step 146). If the profile indicates the caller is known to the recipient, the call is treated as a call from a known caller, and re-routed to step 135. Otherwise the call is from a truly unknown caller, and the caller is prompted to leave a voicemail message, which is placed into the “voicemail” folder (step 147).

7. An Exemplary Process Flow for Electronic Mail

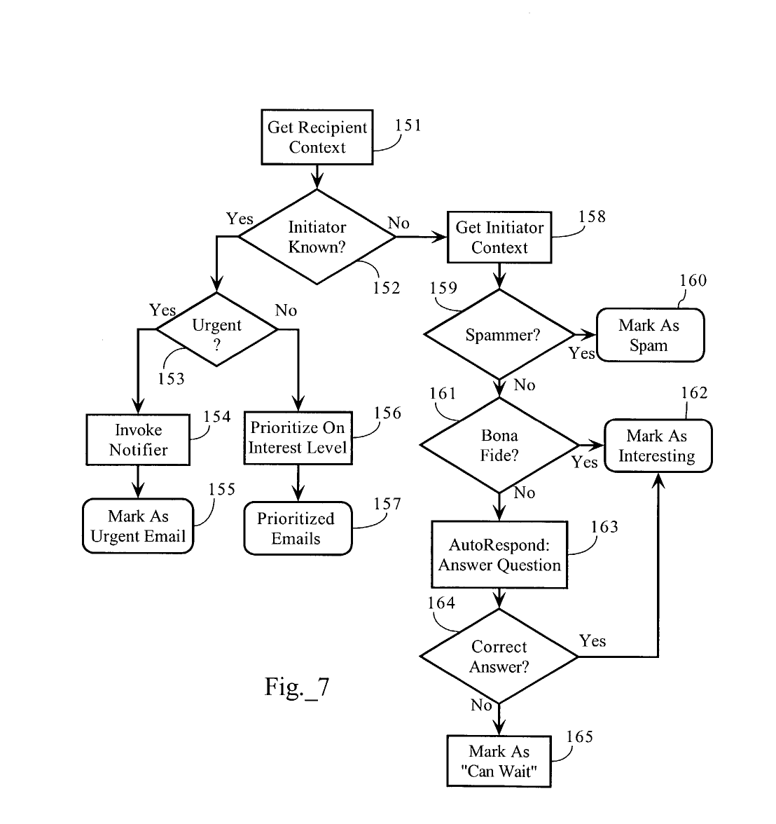

FIG. 7 illustrates a process flow for handling an email by a system according to an embodiment of the present invention. As above, it is assumed that the communication logs and the daily schedule of the subscribers to the service are available.

Emails sent by the sender (the initiator) to the recipient contain header information such as sender's email address in the FROM field, the recipient's email address in the TO field, date and time the email is sent in the DATE field, the SUBJECT field and the BODY field. The email is routed through the communications network to message handler 11. Once the message's relevance is computed and prioritized into a folder, the message interface notifies the email recipient of presence of urgent emails, and permit perusal of the emails by the recipient according to the prioritized folders in the user's inbox.

Processing of the email message begins with passing the email together with the header information to recipient context module 12 to compute the recipient's context (step 151). The resulting contact relation type is checked (step 152). If the sender is known, any interest level computed by recipient context module 12 in step 151 is checked to see if the email is urgent (step 153). If so, the email is passed into a notifier module that can provide more timely and immediate means for alerting the recipient (step 154). Illustrative examples notification functionality include pagers, mobile phone alerts, Short Message Service or Instant Messaging. The email is then placed into the urgent message folder (step 155), which is accessed by message interface 16 for retrieval by the recipient.

Otherwise, non-urgent emails from known senders are contextually prioritized (step 156) according to the contact relation profiles and interest levels computed in step 151. As illustrative examples, emails can be prioritized into folders based on the sender's profile priority levels, such as “Very Important” folder for emails from Related or Trusted senders, “Important” folder for emails from Familiar senders and “Regular” folder for emails from Known senders. A variation is to further differentiate emails from senders of a given profile priority by the recentness of communication, so the more recent communications the higher the prioritization.

In one embodiment, email messages are prioritized based on a combination of the computed contact relation sender profiles and interest levels, such as using a “Important Senders” folder for emails from Related or Trusted senders, a “Time sensitive” folder for email marked with “Returning Call”, “Meeting Soon” and “Meeting Canceled” interest levels, a “Location sensitive” folder for emails containing information specific to where the recipient is and a “By Interest” folder for emails whose content matches the recipient's interest profiles (e.g. email discussion threads related to a project, or emails related to a recipient hobby interest).

If the sender is unknown to the recipient (step 152), the email together with its header information is passed to the initiator context module 13 to compute the initiator's context (step 158). The resulting computed initiator identify profile is checked (step 159). If the computed identity profile matches a Spam profile, then the email is placed into a “Spam” folder (step 160) which is accessed by message interface 16 and presented to user when he or she accesses the system.

If the computed identity profile matches an Affinity or Bona-Fide profile (step 161), the sender is deemed an unknown but credible caller. The email is then prioritized (step 162), based on the profiles computed in step 158. As illustrative examples, emails can be prioritized into a “Possible Friend” folder for emails from senders who communicate regularly with the recipient's regular contacts, a “Possible Colleague” folder for emails from senders who likely work at the same business as the recipient, a “Credible sender” folder for emails from senders who are likely bona-fide senders (as opposed to automated services and spammers).

The remaining emails are deemed to be from truly unknown senders who do not match Spammers or Affinity profiles. In one embodiment, processing of these emails involves the use of auto-interaction module 15 to prompt the sender to provide an equivalent identity by supplying a contact previously used to communicate with the recipient (step 163). An exemplary email prompt by auto-interaction module 15 might be “Hi, I'm sorry I do not recognize you. If this is an urgent email, please enter a phone number or email that you have used to contact John before, or enter the phone number or email of the person who referenced you to John. Otherwise this will be marked as an email from an unknown sender.”

In one embodiment, the message is sent as a reply to the sender's email. Any reply from the sender is scanned for contact information which is then passed to the recipient context module 12 for re-computation (step 164) and the results checked in (step 165). If the supplied contact's profile is known to the recipient, the email is added to the Affinity folders, such as the “Credible Sender” folder, in (step 162). Otherwise the email is placed into an “Unknown Sender” folder (step 166)

8. Conclusion

A system and method for computing the relevance of unified messages has been described. The above-described embodiments of the invention are intended to be illustrative only. Numerous alternative embodiments may be devised by those skilled in the art without departing from the spirit and scope of the invention. Accordingly, the present invention has been described with reference to specific embodiments. Other embodiments of the present invention will be apparent to one of ordinary skill in the art. It is, therefore, intended that the claims set forth below not be limited to the embodiments described above.

What is claimed is:

1. A system allowing for the contextual prioritization of messages, comprising
a message handler operative to interface with a communications network to receive and send messages for at least one user;
a relevance engine operative to compute the relevance of a received message based on the recipient user's context relative to at least one attribute of the received message; and
a message interface operative to facilitate the sending and retrieval of messages for the at least one user.

2. The system of claim 1 wherein the relevance engine is operative to categorize the received message into one of a plurality of predefined relevance categories.

3. The system of claim 1 wherein the message interface provides a user interface including a plurality of folders corresponding to the predefined relevance categories.

4. The system of claim 3 wherein the relevance engine is operative to prioritize the message into one of the plurality of folders based on the identified relevance category.

5. The system of claim 1 further comprising a recipient context module operative to compute a recipient user's context in relation to a received message.

6. The system of claim 5 wherein the recipient context module is operative to compute the recipient user's context by identifying a contact relation type between the recipient user and the initiator of the received message.

7. The system of claim 6 wherein the recipient context module is operative to categorize the recipient user's context with respect to the received message into one of a plurality of contact relation types relative to the initiator of the received message.

8. The system of claim 6 wherein the recipient context module is further operative to compute the recipient user's interest level for the received message.

9. The system of claim 8 wherein the recipient context module is operative to compute the recipient user's interest level in the received message based on a predefined set of heuristic rules.

10. The system of claim 5 further comprising an inference module and a communications log, wherein the communications log stores data relating to the messages sent and received by at least one user, wherein the inference module is operative, in relation to the at least one user, to make inferences, based on a set of inference rules, from the data stored in the communications log and segregate the at least one user's contacts into a pre-defined set of contact relation types.

11. The system of claim 10 wherein the recipient context module is operative to categorize a received message based on the contact relation type between the recipient user and the initiator of the message computed by the inference module.

12. The system of claim 10 further comprising a user profile database storing a plurality of user contact pairs and contact relation types corresponding to the user contact pairs, and wherein the inference module is operative to store user contact pairs and computed contact relation types in the user profile database.

13. The system of claim 12 wherein the recipient context module is operative to access the user profile database to identify a contact relation type between a recipient user and the initiator of a received message.

14. The system of claim 10 wherein the inference module operates in a separate, background process relative to the relevance engine.

15. The system of claim 1 further comprising an initiator context module operative to determine the context of the initiator relative to a received message.

16. The system of claim 15 wherein the relevance engine is operative to pass received messages associated with initiator's unknown to the recipient user to the initiator context module.

17. The system of claim 15 further comprising an initiator identity profile database storing initiator identity profiles computed by the initiator context module.

18. The system of claim 15 wherein the initiator context module is further operative to compute a content profile for received messages.

19. The system of claim 18 wherein the relevance engine is operative to compute the relevance of received messages based on the corresponding initiator's context and content profile computed by the initiator context module.

20. The system of claim 1 wherein the message handler includes unified messaging functionality allowing for the receipt and sending of a plurality of message types.

21. The system of claim 20 wherein the message types comprise at least one of the message types selected from the group consisting of voice calls, voice messages, faxes, text messages, SMS messages, faxes, and emails.

22. A method allowing for the contextual prioritization of messages in a messaging system, comprising
receiving a message from an initiator on behalf of a recipient user;
computing the recipient user's context relative to the received message;
categorizing the received message into one of a plurality of prioritization categories based at least in part on the recipient user's context relative to the received message.

23. The method of claim 22 wherein the categorizing step further comprises prioritizing the message into one of a plurality of contextually prioritized folders.

24. The method of claim 22 further comprising
maintaining a communications log storing data relating to messages encountered by the messaging system;
operating on the data in the communications log to create initiator-recipient contact pairs and determining a corresponding contact relation type for the initiator-recipient contact pairs based on a predefined set of rules; and
storing initiator-recipient contact pairs and corresponding contact relation types in a user profile database.

25. The method of claim 24 wherein the computing step comprises
access the user profile database to retrieve an initiator-recipient contact pair matching the recipient user and initiator associated with the received message.

26. The method of claim 25 further comprising
setting the contact relation type to unknown if no matching initiator-recipient contact pair is retrieved.

27. The method of claim 26 further comprising
computing the initiator's context relative to the received message, if the contact relation type associated with the message is unknown.

28. The method of claim 27 wherein computing the initiator's context comprises
determining the initiator's identity profile by applying a predefined set of heuristic rules.

29. The method of claim 28 wherein the determining the initiator's identity profile comprises
testing for one or more affinity relation types between the recipient user and the initiator.

30. The method of claim 28 wherein the determining the initiator's identity profile comprises
testing whether the initiator is bona fide based on examination of the initiator's contacts with other users.

31. The method of claim 28 further comprising
computing a content profile for the message and comparing the computed content profile to one or more screening profiles.

32. The method of claim 31 wherein at least one screening profile is adapted to detect spam messages.

33. The method of claim 22 wherein the computing the recipient user's context comprises
determining a contact relation type between the recipient user and the initiator; and
if the initiator is known to the recipient user, computing an interest level the recipient user may have in the received message.

34. An apparatus allowing for the contextual prioritization of messages, comprising
a recipient context module operative to compute a recipient user's context in relation to a received message;
an initiator context module operative to determine the context of the initiator relative to a received message;
a relevance engine operably coupled to a communications network to monitor the transmission and receipt of messages for at least one user, wherein the relevance engine is operative to compute the relevance of a received message based, at least in part, on the recipient user's context relative to at least one attribute of the received message, wherein the relevance engine is operative to pass received messages to the recipient context module, and wherein the relevance engine is operative to pass received messages associated with initiator's unknown to the recipient user to the initiator context module.

35. The apparatus of claim 34 wherein the relevance engine is operative to categorize the received message into one of a plurality of predefined relevance categories.

36. The apparatus of claim 34 further comprising an auto-interaction module operably coupled to the communications network and operative to auto-interact with a message initiator.

37. The apparatus of claim 36 wherein the relevance engine is operative to invoke the auto-interaction module in response to a received message from an initiator unknown to the recipient user.

38. The apparatus of claim 37 wherein the auto-interaction module is operative to query the initiator for information relevant to a determination of a contact relation type between the initiator and the recipient user.

39. The apparatus of claim 38 wherein auto-interaction module is operative to query the initiator for information relevant to a determination of the initiator's context.

40. The apparatus of claim 34 further comprising
a message handler operative to interface with the communications network to receive and send messages for at least one user;
a message interface operative to facilitate the sending and retrieval of messages for the at least one user.

41. The apparatus of claim 40 further comprising
an inference module and a communications log, wherein the communications log stores data relating to the messages sent and received by at least one user, wherein the inference module is operative, in relation to the at least one user, to make inferences, based on a set of inference rules, from the data stored in the communications log and segregate the at least one user's contacts into a predefined set of contact relation types.

42. The apparatus of claim 41 further comprising a contacts database storing data relating to the contacts associated with at least one user, wherein the inference module is operative, in relation to the at least one user, to make inferences, based on a set of inference rules, from the data stored in the communications log and the contacts database and segregate the at least one user's contacts into a pre-defined set of contact relation types.

43. The apparatus of claim 42 wherein the recipient context module is operative to categorize a received message based on the contact relation type between the recipient user and the initiator of the message computed by the inference module.

44. The apparatus of claim 43 further comprising a user profile database storing a plurality of user contact pairs and contact relation types corresponding to the user contact pairs, and wherein the inference module is operative to store user contact pairs and computed contact relation types in the user profile database.

45. The apparatus of claim 44 wherein the recipient context module is operative to access the user profile database to identify a contact relation type between a recipient user and the initiator of a received message.

46. The apparatus of claim 42 wherein the inference module operates in a separate, background process relative to the relevance engine.

47. The apparatus of claim 34 further comprising an initiator identity profile database storing initiator identity profiles computed by the initiator context module.

48. The apparatus of claim 47 wherein the initiator context module is further operative to compute a content profile for a received message.

49. The apparatus of claim 48 wherein the relevance engine is operative to compute the relevance of received messages based on the corresponding initiator's context and content profile computed by the initiator context module.

50. The apparatus of claim 40 wherein the message handler includes unified messaging functionality allowing for the receipt and sending of a plurality of message types.

51. The system of claim 50 wherein the message types comprise at least one of the message types selected from the group consisting of voice calls, voice messages, faxes, text messages, SMS messages, faxes, and emails.
